(19) United States
(12) Patent Application Publication
(10) Pub. No.: US 2024/0294211 A1
(43) Pub. Date: Sep. 5, 2024

(54) Truck Body Roof Installation

(71) Applicant: Morgan Truck Body, LLC, Morgantown, PA (US)

(72) Inventors: William Hurst, New Holland, PA (US); Aaron Cody VanDyke, Pennsburg, PA (US)

(73) Assignee: Morgan Truck Body, LLC, Morgantown, PA (US)

(21) Appl. No.: 18/593,839

(22) Filed: Mar. 1, 2024

Related U.S. Application Data
(60) Provisional application No. 63/449,622, filed on Mar. 3, 2023.

(51) Int. Cl. B62D 25/06; B62D 33/04; B62D 33/077

(52) U.S. Cl. CPC B62D 25/06; B62D 33/04; B62D 33/077

(57) ABSTRACT

A truck body roof Installation with an edge cap for attachment of a roof onto a truck body. The edge cap construction and installation on the truck body secures the roof the top rail of the truck body with adhesive and without holes or localized fasteners. The edges of the roof are bonded and sealed to the top rail with a layer of adhesive applied and held by the edge cap between the roof and the truck body with a desired adhesive curing thickness. The edge cap construction and installation mitigates water penetration and mechanically protects the roof edges.

### CROSS-REFERENCE TO RELATED APPLICATIONS

This application claims the benefit under 35 U.S.C. § 119(e) to U.S. Provisional Patent Application Ser. No. 63/449,622, filed on Mar. 3, 2023. U.S. Provisional Patent Application Ser. No. 63/449,622, is incorporated herein by reference in its entirety, including all drawings and exhibits.

### BACKGROUND OF INVENTION

### Field of the Invention

The invention relates to construction and installation of a roof on a truck body.

### Background Art

Traditional roof installations on truck bodies involve punching or drilling holes through the edge of a roof and top rails attached to the side walls of a truck body. The roof is attached by installing fasteners such as rivets, screws or bolts through the roof edge and the top rails to attach the roof. In prior installations, potential areas for leaks are created by punching or otherwise making holes in the edge of the roof to accommodate fasteners. This invention helps eliminate water intrusion by eliminating holes and localized fasteners spaced along the edge of the roof and by using a continuous layer of adhesive to form a bonded and sealed connection between the roof and the top rails of the truck body.

In one or more embodiments, a truck body roof construction and method of installation provides an edge cap for the attachment of a roof onto a truck body. The construction, edge cap, and installation secure the roof on the top rail of the truck body with a uniform thickness layer of adhesive and without making holes or using rivets, screws, or other localized fasteners. The edges of the roof are bonded and sealed to the top rail with a continuous layer of adhesive that is held by the edge cap and cured in place. The construction and method of installation mitigates water penetration.

### SUMMARY OF INVENTION

In one or more embodiments the truck body roof installation comprises an edge cap installed along the top rail for structurally establishing the thickness of the applied adhesive during curing and bonding the roof to the top rail. The structure of the edge cap is formed to establish and maintain the desired thickness of the adhesive for effective bonding strength. The edge cap remains in place during and after curing and adds uniform mechanical support along the bonded area of the roof edge. The edge cap covers the edge of the roof and encapsulates an outward edge of the top rail to reduce peeling of the roof edge and to protect the outward edge of the top rail when the truck body is being used.

Other aspects and advantages of the invention will be apparent from the following description and the appended claims.

### BRIEF DESCRIPTION OF DRAWINGS

FIG. 1 is a schematic perspective assembly view of a truck body and roof Installation.

FIG. 2 is a schematic partial cutaway, perspective view of an embodiment of an edge cap employed in the truck body roof installation according to one or more embodiments of the invention.

FIG. 3 is a schematic section view vertically through an embodiment of an edge cap applied for the truck body roof installation according to one or more embodiments of the invention.

FIG. 4 is a schematic section view vertically through an edge cap applied for the truck body roof installation to an alternatively formed top rail according to one or more embodiments of the invention.

FIG. 5 is a schematic cross section/silhouette view vertically through a top rail for a truck body, wherein the top rail is formed with a rounded outward edge according to one or more embodiments of the invention may be used.

FIG. 6 is a schematic cross section view corresponding to an example shop drawing showing a geometric structure of an edge cap 50 according to one or more embodiments of the invention.

FIG. 7 is a schematic section view vertically through an edge cap applied for the truck body roof installation to an alternatively formed top rail according to one or more embodiments of the invention.

FIG. 8 is a schematic cross section/silhouette view vertically through the alternative top rail of FIG. 7 for truck body roof installation according to one or more embodiments of the invention.

FIG. 9 is a schematic depiction of a portion of a prior art truck body roof assembly showing a series of individual compression indentations on an edge of a roof that was riveted to the top of a truck body and showing rivets locally compressing and deforming the exposed roof edge fastened by the rivets to the top rail of a truck body.

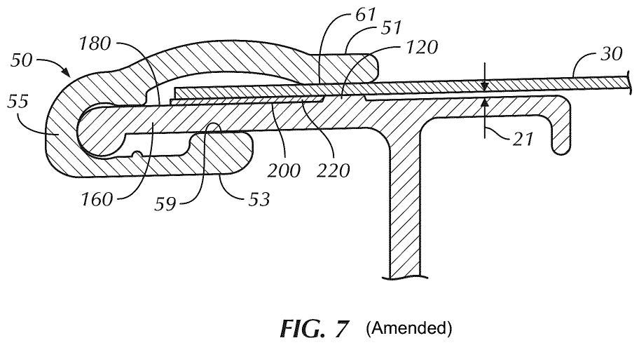

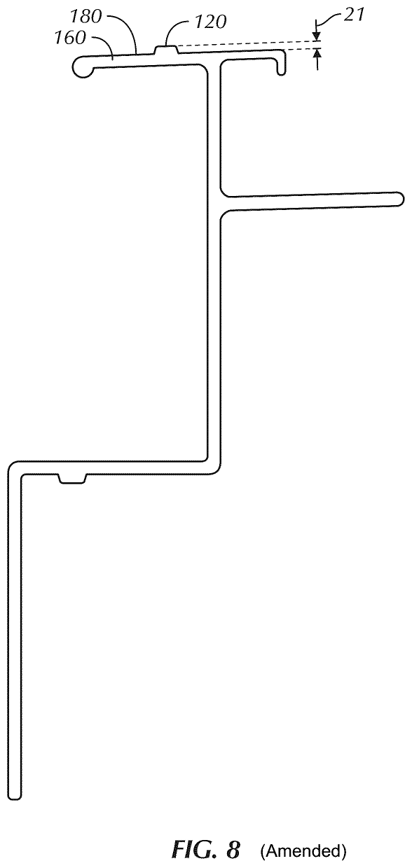

FIG. 8 is a schematic cross section/silhouette view vertically through the alternative top rail of FIG. 7 for truck body roof installation according to one or more embodiments of the invention.

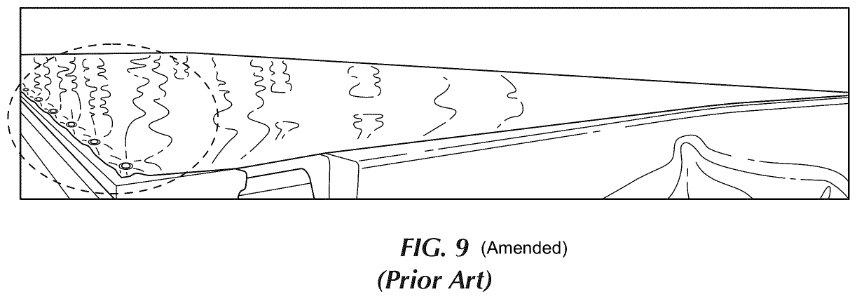

FIG. 9 is a schematic depiction of a portion of a prior art truck body roof assembly showing a series of individual compression indentations on an edge of a roof that was riveted to the top of a truck body and showing rivets locally compressing and deforming the exposed roof edge fastened by the rivets to the top rail of a truck body.

### DESCRIPTION

It has been found by the inventors that there are some deficiencies in a traditional truck body roof installations that involve punching holes and installing rivets or other fasteners through the edge of the roof and into the top rails of the truck body. It has been found that punched holes in the roof are difficult to seal and can create leaks over time. It has also been found that by using rivets or other fasteners that apply localized force in the immediate area of the fastener, the roof edge can be deformed or warped during the installation and during use of the truck body by repetitious shaking and vibration. If a gasket or other seal is used between the roof edge and the top rail, the localized deformation or warpage allows wind and water to buffet along the edge, thereby increasing the instances of loosening or peeling at the holes and the deformed areas caused by the fasteners that are spaced along of the roof edge; potentially resulting in air and water leakage during use.

One or more embodiments of the invention overcome deficiencies found by the inventors in prior truck body roof installations, constructions, and methods. In one or more embodiments of the invention an edge cap construction and a method of installation of a roof on a truck body eliminates or significantly reduces water intrusion through the connection between the roof and truck body. In one or more embodiments of the invention the connection between the roof and truck body is made with an installation that eliminates the use of holes and fasteners for the roof installation. The edge cap construction allows roof installation using adhesive held and cured under the edge cap in a desired uniform thickness adhesive layer, instead of localized pressure fasteners. The edge cap compresses and holds the roof edge in place for adhesive bonding to the top rail of the truck body. A substantially uniform force is applied by the edge cap over the length of the connection while the adhesive cures. In one or more embodiments the roof edge cap and method of roof installation may be useful for installing a roof on a medium duty dry freight truck body or a refrigerated box truck body. In one or more embodiments the inventive roof installation system mitigates water penetration and adds mechanical protection to the edge of the roof and the truck body. In one or more embodiments the roof edge cap provides protection from the effects of the elements such as wind, water, snow, ice, and debris so that peeling of the roof material from the frame is reduced. In one or more embodiments the roof edge cap provides protection to the top rail of the truck body along the outward edge of the truck body frame by retaining the edge cap in place covering and concealing the outward edge after roof installation is completed. The edge cap also mechanically protects the top rail edge and the edge of the roof from tree limbs, low hanging structures, debris carried by wind and water, and from other roadway materials and objects that could otherwise impact the top rail and potentially cause damage to the truck body during use.

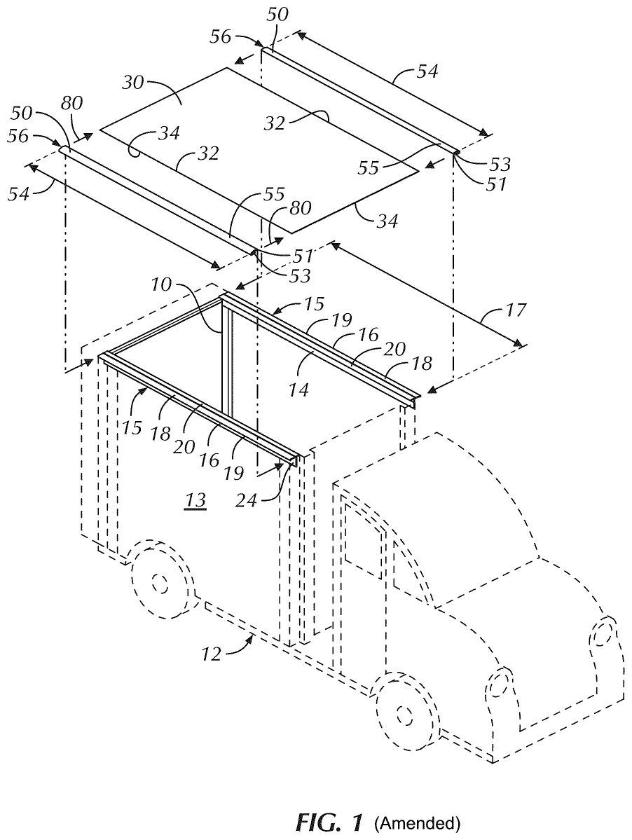

In FIG. 1 a schematic perspective assembly view shows an embodiment of a roof sheet 30 formed for installation on a top rail 16 of a frame 14 of a truck body 12. The truck body 12 is shown with dashed lines. An edge cap 50 is shown on either side, with arrows 80 showing the assembly movement of the edge cap 50 over and an edge 32 of the roof 30 for assembly onto a top surface 18 of the top rail 18 of the truck body frame 14.

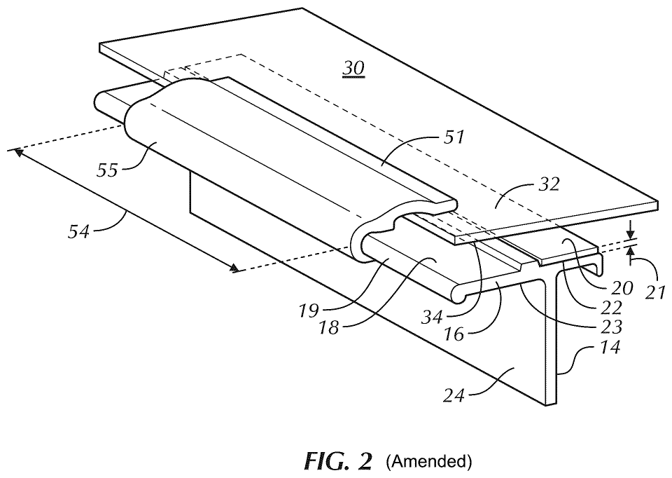

In FIG. 2 a schematic partial cutaway, perspective view shows an embodiment of the edge cap 50 employed for the truck body roof installation. The schematic perspective view shows an embodiment of construction of the edge cap 50, top rail 16, and roof sheet 30 assembly. The edge cap 50 is schematically shown installed onto the top rail 16 of the truck body frame 14 (not shown in FIG. 2). The edge cap is clamped over an outward edge 19 of a top rail 16 and also clamped over an edge 34 of the roof sheet 30 for holding the roof 30 onto the top surface 18 of the top rail 16 according to one or more embodiments of the invention. The elongated edge cap 50 is shown pressed onto the top rail 16 along one edge 34 of the roof 30 of the truck body. The top rail 16 and the edge cap are separately formed of metal, such as aluminum, as by extrusion to produce a length with the indicated unique cross-sectional shape there along. For the roof installation the edge cap snaps on or slides on the top rail and provides clamping pressure on the roof edge until the adhesive cures. An offset at the clamping surface provides space for an adhesive bead with a control of thickness. Adhesive is also used to secure the roof to a roof bow (not shown) if used in the construction for supporting the roof between opposed top rails 16 across the frame 14 of the truck body 12 from one side to the other.

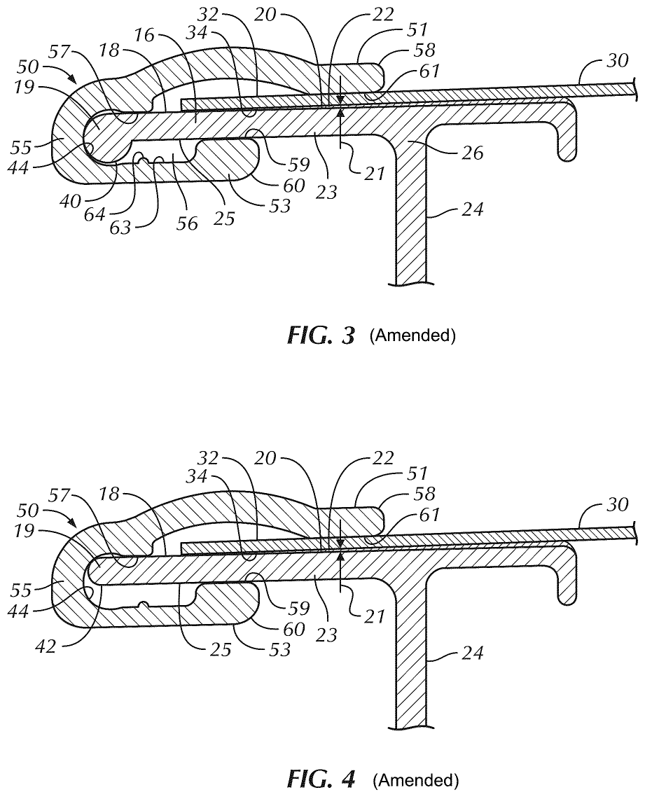

FIG. 3, is a schematic cross section view depiction of an embodiment of construction of an edge cap, top rail, roof sheet assembly. The schematic section view is taken vertically through an embodiment of an edge cap 50 showing the edge cap 50 installed over the top rail 16 and covering the edge 32 of the roof sheet 30 for the truck body roof installation according to one or more embodiments of the invention.

With reference to FIGS. 1, 2, & 3, according to one or more embodiments of the installation method and construction, a frame 10 of a truck body 12 is constructed with top frame 14 having top rails 16 including outward edges 19 of the top rails 16. In the roof installation, a roof sheet 30 is formed of a thin durable material in a shape and size defined by top roof edges 32 corresponding to a size and shape of the top frame 14. For example, both the top frame 16 of the truck body 12 and the roof sheet 30 may be formed in the shape of rectangles with substantially the same size and shape. The top frame 14 may be comprised of a plurality of top rails 16, made of metal such as extruded aluminum, cut to the length 17 of edges of the top frame and connected to each other at corners to form a top frame 14. For example, for a rectangular shaped truck body 12, the top frame 14 may also have a rectangular shape. The top rails 16 may comprise a “T” cross section portion 26, the top of which comprises a generally horizontal top support 23 having a top surface 18 of the top rail 16, at which a roof edge 32 of a roof sheet 30 may be attached to the top rail 16 with adhesive 20 using the edge cap 50. The generally horizontal top support 23 also comprises a generally horizontal bottom surface 25. Another part of the of the “T” cross section portion 26 of the top rail 16 comprises a generally vertical support structure 24, by which the top rail 16 is connected to a wall 13 of the truck body 12.

According to one or more embodiments of the installation method and construction, an adhesive 20 is applied in a substantially continuous bead, strip, or layer 22 along a length 17 of a top surface 18 of a top rail 16 of the top frame 14 of the truck body 12. The roof sheet 30 is placed overlaying the top frame 14 of the truck body 12, and roof sheet 30 is positioned so that a perimeter edge 32 of the roof sheet 30, is aligned with the adhesive layer 22 applied along the length 17 of the top rail surface 18. Usefully, the adhesive 20 is applied in a continuous bead or layer 22 along the length 17 extending along the top surface 18. The length 17 of the top rail surface 18 to which the adhesive 20 is applied corresponds to the length of the roof edge 32. The roof edge 32 and the top rail 16 are pushed or compressed toward each other by installing the edge cap 30 over the outward edge 19 of the top rail 16 and extending over and against the top roof edge 32 with the adhesive 20 applied in a layer 22 between a bottom roof edge 34 and a top rail surface 18.

According to one or more embodiment of the installation method and construction, the edge cap 50 is constructed having a length 54 substantially corresponding to the length 17 of the top rail surface 18 to which the adhesive layer 22 is applied. According one or more embodiments of the invention, the edge cap 50 is constructed as an elongated channel 54 with length 54 and having a cross section shape 52 that might be described as a generally flattened “C” shape or a sideways “J” shape. The edge cap 50 comprises an upper flange 51 and a lower flange 53 that are interconnected to each other by a connection elbow 55. The flanges 51 and 53 and the elbow 55 are preferably integrally formed of metal or another durable material. The flanges 51, 53, and elbow 55, shown in the cross-section views and extend the length 54 of the edge cap 50 forming the elongated channel 56, as shown in FIG. 1, with the cross-section shape 52 there along, as shown in FIGS. 2 and 3. The edge cap 50 is usefully made of a strong resilient material such as metal, rubber, or a polymeric material. An open interior of the channel 56 is formed between the connected flanges 51 and 53 and the connection elbow 55, which define interior contact surfaces 57 and 59 along the channel 56. The interior contact surfaces 57 and 59 are strategically formed to contact with a top surface 18 and a bottom surface 25 of the top rail 16 for installation of the roof 30. In one or more embodiments the edge cap 50 may be made by extrusion, molding, or machining processes. In one or more embodiments the edge cap 50 is made of extruded aluminum.

According to one or more embodiments, depicted in FIGS. 2, and 3, the upper and lower flanges 51 and 53 of the edge cap 50 are spaced apart along the interior surfaces of the channel 56. The flanges 51 and 53 extend inward from the connection elbow 55 and toward the inward end 58 of the upper flange 51 and toward the inward end 60 of the lower flange 53. The spacing between the flanges 51 and 53 is established to allow the upper flange 51 to be movably positioned over the top rail 16 and over the edge 32 of the roof sheet 30. The spacing between the flanges 51 and 53 is also established to allow the lower flange 53 to be positioned under the generally horizontal top support structure 23 of the top rail 16. Thus, the spacing between the upper flange 51 and lower flange 53 accommodates the combined thickness of the top rail 16, the thickness of the roof edge 32, and the desired thickness 21 of the adhesive layer 22 for effective curing.

In one or more embodiments of the roof installation, the spacing between the upper flange 51 and the lower flange 53, and the configuration of the interior channel 56 of the edge cap 50 are established to receive the top rail 16 into the channel 56, so that the edge cap 50 may be moved onto the outward edge 19 of the top rail 16 with the upper flange 51 over the top rail surface 18 and the lower flange 53 may be moved past the edge 19 and under the lower surface 25 of the top rail 16. The edge cap 50 is physically movable onto the top rail 16 by flexure of the flanges 51 and 53 so that the edge cap 50 may be pushed into place at an inside crook surface 44 of the elbow 55 encapsulating the outward edge 19. The outer edge 19 of the top rail 16 is preferably rounded with a diameter 40 that that is slightly smaller than the crook 44 into which it is inserted and slightly larger than the thickness of the top rail 16. The engagement of the outward edge 19 with the inside surface 44 at the elbow 55 effectively positions the edge cap 50 relative to the top rail 16, so that there is surface-to-surface contact between an edge cap interior contact surface 57 with the top surface 18, and there is surface-to-surface contact between an edge cap interior contact surface 59 with the bottom surface 25 of the top rail 16. A roof contacting surface 61 is formed at the end 58 of the top flange 51 and its position over the roof edge 32 will be established by the structure of the edge cap 50 and the locations of the surface-to-surface contact between contact surface 57 against top surface 18 and the surface-to-surface contact between contact surface 59 and bottom surface 25. The result is effectively three points of contact (or three surfaces of contact), so the location of the edge cap contact surface 61 for contact with roof edge 32 is established by the location of the contact points of contact at surfaces 57 and 59. With adhesive layer 22 applied under the roof edge 32, the contact surface 61 is designed to contact with the top the roof edge 32. A clamping force will be applied by the flange 51 at contact surface 61 to push the edge 32 of the roof 30 against the layer 22 of adhesive 20 until the desired curing thickness 21 of the adhesive layer is achieve as established by the three points of contact. The amount of clamping force applied to the roof edge 32 by the installed edge cap 50 for compressing the adhesive layer 22 to the desired bonding thickness 21 may be established by the relative positions of the surface-to-surface contacts at contact surfaces 57, 59, and 61, by the location of the roof edge contact surface 34, by the structure of the edge cap 50, by the material strength, and by the resilience (according to the modulus of elasticity) of the material forming the edge cap 50.

FIG. 4 is a schematic cross section view depiction of one embodiment of construction of an edge cap, top rail, roof sheet assembly. The schematic section view is taken vertically through an embodiment of an edge cap 50 installed over an alternative formed outward edge of the top rail, according to one or more alternative embodiments for the roof installation. FIG. 4 shows an outward edge 19 of the top rail having beveled or rounded corners 42 such that the rounded outward edge 19 has a diameter that is substantially the same as the thickness of the top rail 18. The roof 30 in position with the roof edge 32 is aligned with the top surface 18 of the top rail 16. The flanges 51 and 53 of the edge cap 50 are moved inward over the outward edge 19 of the top rail until the outward edge 19 contacts the crook 44 of the elbow 55 so that the interior contact surface 57 of the upper flange 51 contact the top surface 18 adjacent to outward edge 19 of the top rail 16 and the lower flange 53 of the edge cap 50 is positioned for contact engagement at contact surface 59 with the under surface 25 of the top rail 16. The point of contact between surfaces 18 and 57 and the inwardly space point of contact between surfaces 25 and 59 effectively establish the orientation of the edge cap 50 relative to the top rail 16. The structure of the edge cap 50 establishes the orientation of the upper flange 51 and thereby the orientation and distance of a contacting surface 61 on the end 58 of the top flange 51. By pushing the end cap 50 onto the top rail 16 so that the interior surface of crook 44 is in contact with the outward edge 19 of the top rail 16, the contact surface 61 is positioned over the roof edge 32. By the structure of the edge cap 50, the contact surface 61 applies clamping force contact against the roof edge 32. Thus, by the structure of the edge cap 50, the thickness 21 of the adhesive layer 22 is established at which clamping force will continue to be applied by the edge cap 50. According to the positional relationship of contact surfaces 57, 59, and 61 (i.e., three points of contact at a given cross section or three lines of contact along the length 54 of the edge cap), the desired thickness 21 of the adhesive layer 22 is established and the clamping force will be applied by the edge cap 50 and transmitted through the roof edge 32 to compress the adhesive 20 applied between the roof and the top rail.

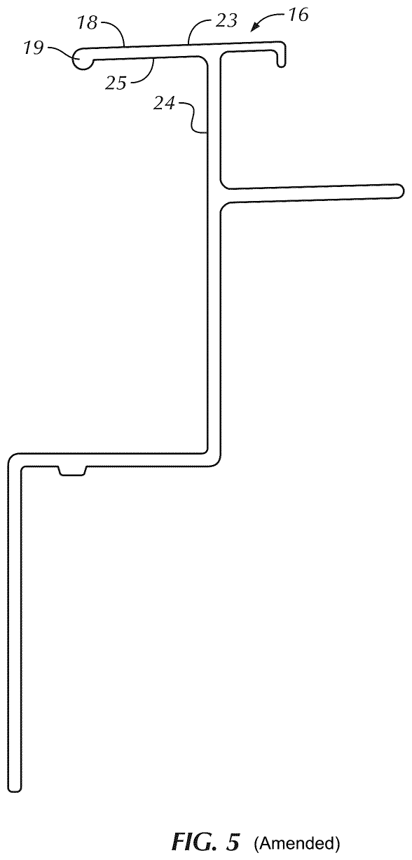

In FIG. 5 a schematic cross section/silhouette view vertically through a top rail for a truck body, shows a top rail structure is formed with a rounded outward edge 19 wherein the rounded edge 19 has a diameter 40 slightly larger than the thickness of the top rail 16 according to one or more embodiments of the invention.

With reference also to FIGS. 3 & 5, according to one or more embodiments of the invention, the structure of edge cap 50 provides the spacing between the inside of the upper flange 51 and the inside of the lower flange 53 of the edge cap to accommodate the diameter of the rounded outward edge 19 of the top rail 16. The spacing is formed sufficiently wide to allow the upper and lower flanges 51 and 53 of the edge cap to move over the rounded outward edge 19 of the top rail 16 while accommodating the height of the roof sheet above the surface 18 with a layer of adhesive between the roof sheet and the surface 18 of the top rail 16, and without squeezing out all of the adhesive 20 from layer 22. The edge cap 50 may be moved inward until the rounded end 19 of the top rail meets a raised ridge 64 formed on the interior surface 63 to provide localized narrowing of the spacing between the flanges 51 and 53. Moving the rounded outward edge 19 past the ridge 64 mechanically causes the connected flanges to be elastically spread until the rounded outward edge 19 of the top rail 16 is moved past the ridge and the rounded edge 19 is inserted into the rounded crook 44 at elbow 55 of the edge cap 50. The outward edge 19 engages the crook 44 with the end 58 of the top flange 51 positioned over the edge 32 of roof sheet 30 adjacent to the applied adhesive layer 22. When the elasticity of the material of the edge cap 50 snaps over the ridge 64 and the flanges return to a non-spread position, the contact surface 61 of the top flange 51 moves into contact with the edge 32 of roof sheet 30. The edge cap 50 clamps on the roof edge 32 and forces the bottom roof edge surface 34 downward. Because the contact position of contact surface 61 is established by the structure and locations of the contact surfaces 57 and 59, downward force will be applied by upper flange 51 until the adhesive layer 22 is squeezed to the desired thickness 21. The roof edge 34 is depressed sufficiently to accomplish continuous adhesive applied and bonded between and along the length of the bottom roof edge 34 and the top surface 18 of top rail 16.

The amount of resistance to the compressive force that results from the area and compressibility of the adhesive layer, should balance when the thickness of the adhesive layer 22 is compressed to the desired bonding thickness 21. For example, a low viscosity adhesive 20 may provide little resistance to compression so that the thickness of the adhesive will be nearly identical to the spacing of the contact surface 61 without any flexure of the edge cap. With a very high viscosity adhesive 20, resistance to compression might be significant and the balance of the adhesive resistance and the clamping force may occur with a slightly more viscous adhesive material than would occur with a less viscous adhesive. In either case the desired thickness of the adhesive is predetermined based upon the edge cap structure, the structure of the top rail, the thickness of the roof sheet, the area covered by the adhesive and the compressibility characteristics of the adhesive.

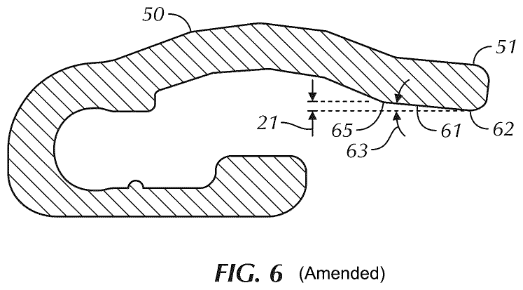

In FIG. 6 a schematic cross section view corresponding to an example shop drawing showing a geometric structure of an edge cap 50 according to one or more embodiments of the invention.

With reference also to FIG. 6, according to one or more embodiments the edge cap 50 is formed with the contact surface 61 is oriented at a small angle 63 relative to the generally horizontal top surface 18 of the top rail. For example, an inward most part or tip 62 of contact surface 61 may be closer to the top surface 18 by a small distance, for example a distance corresponding to the desired thickness 21 of the adhesive layer 22. The outward part or heel 65 of the contact surface 61 will be raised up relative to the tip 62. With the edge cap 50 installed, tip 62 is vertically closer to the roof than the heel 65 and the tip 62 applies clamping force to the roof. The viscosity of the adhesive 20 will resist contact under the contact surface 61. However, the squeezing force or clamping pressure will be greater in the area the tip 62 and it will be less in the area of the heel 65. Thus, there will be less squeezing of the adhesive 20 under the relatively raised heel 65 of the contact surface 61. If surface-to-surface contact occurs between the roof and top rail in the area of the tip 62, a thickness of adhesive will remain in the area of the heel because it is raised that much by the angle 63 of the contact surface 61. The desired thickness 21 of the adhesive layer 22 is thereby maintained for curing and bonding in the area under the heel 63 of the contact surface 61 for the truck body roof installation.

In another example alternative embodiment, as shown in FIGS. 7 and 8, an alternatively formed top rail 160 may be provided having a raised surface 120 that is positioned on the top surface 180 of the top rail 160, so that the edge 32 of the roof sheet 30 is laid over and engages against the raised surface 120. In one or more embodiments the raised surface 120 has a raised height above the top surface 180 of the top rail 160 corresponding to the desired adhesive thickness 23. The bead of adhesive 20 is applied initially thicker than the height of the raise surface 120. The edge cap 50 is installed as described above so that its structure applies clamping force to compress the adhesive to a desired curing thickness 21 and holds that position during and after the adhesive 20 is cured in a layer 22 having the desired thickness 21. In this embodiment the height of the raised surface corresponds to the desired adhesive thickness 21 for curing. The contact surface 61 of edge cap 50 clamps against the roof edge 32 and the applied adhesive 20 until the edge surface 34 the roof 30 is in direct contact against the raised surface 120. The clamping force is resisted and balanced when the roof surface 34 directly contacts the raised surface 120 at the height corresponding to the desired adhesive thickness 23. A desired curing thickness 23 of the adhesive that is equal to the height of the raised surface 120 is thereby maintained between the roof edge surface 34 and the top rail surface 18.

In one or more alternative embodiments, an adhesive 20 may be selected as a type having a plurality of solid beads (such as glass micro beads) mixed into the matrix of the adhesive to which clamping force is applied by the edge cap 50. In such a mixture the diameter of the glass micro bead may be substantially uniform throughout the mixture and the glass beads diameter may be selected to correspond to a desired thickness for curing the adhesive. When compressive force is applied to the adhesive, the beads may effectively provide sufficient resistance to balance against the compression force when thickness of the adhesive is substantially equal to the diameter of the solid beads.

In one or more embodiments, the edge cap 50 is constructed so that an interior surface of the distal portion 55 of the flange 51 is positioned at a predetermined spacing from an interior surface of the distal portion 56 of the lower flange 53 in contact with the under surface 24 the top rail 16. The predetermined spacing of flange 51 at the roof edge 32 is adjusted by the size and interior shape of the edge cap 50, relative to the physical dimensions of the top rail 16, the thickness of the roof sheet 30, and the desired thickness of the adhesive 20 for effective sealing and boding strength upon curing. An interior surface portion of upper flange 51 is thereby spaced at a position above the top surface of the roof edge 32 for contacting with the roof sheet 30 with clamping force until the desired thickness of adhesive is achieved between the roof edge and the top surface of the top rail. The upper flange 51 and lower flange 53 are continuously interconnected along the length 54 of the edge cap 50. The adhesive is applied in a bead or ribbon having a thickness greater than the desired curing thickness so that the adhesive is compressed by the edge cap to a controlled thickness continuously along and between the bottom surface of the roof edge 32 and the upper surface of the top rail of the frame of the truck body. The interior surface of connection portion of the edge cap contacts or engages the outward edge 19 of the top rail 16 to maintain the inward positioning of the flanges 51 and 53 of the edge cap 30.

According to one or more embodiments of the installation method and construction, “three point” contacting connection (in the case of the elongated edge capo three lines of contacting connection) is accomplished along the first and second flanges applied to the top rail to mechanically secure the edge cap 50 in place on the top rail 16, and to hold the distal interior surfaces of flanges 51 and 52 toward each other with a space therebetween. The spacing and resilience of the material of the edge cap 50 accommodates the movement of the edge cap 50 over the outward edge of the top surface 18 of top rail 16 until the inward portion of the upper flange 51 is positioned over the edge 32 of the roof sheet 30. The upper flange 51, lower flange 53, and the elbow portion of the edge cap connecting therebetween are constructed to allow the edge cap 30 to flex slightly apart as required to move over the outward edge of the top rail 16 and the edge of the roof 32 to compress the adhesive between the lower surface of the roof edge and the upper surface of the top rail to a desired uniform thickness. the three points (or three lines) of contact construction holds the surface at the distal end 51 a desired distance above the bonding surface the top rail 16 so that the adhesive can cure and bond between the roof edge 32 and the top rail 18 the desired compression force and thickness of the adhesive maintained. This can optimize both the bonding strength with the surfaces and the shear strength of the cured adhesive.

According to one or more embodiments of the installation method and construction, the edge cap is constructed to mechanically hold onto the outward edge of the top rail of the truck body both during and after the adhesive is cured. The edge cap maintains the desired small spacing filled with the adhesive while the adhesive cures and it continues to mechanically hold the roof in place against the adhesive along the entire length of the roof edge and the top rail along which the edge cap is installed. The edge of the roof is securely bonded to the top rail, the adhesive forms a watertight seal, the roof is installed and mechanically held in place both whole the adhesive is curing and after the bonding is completed, without the use of holes through the roof or the top rail and rivets, bolts, or other fasteners through the holes or other fasteners that may provide localized force at spaced apart locations along the edge of the roof.

According to one or more embodiments of the installation method and construction, the edge cap continues to provide mechanical support, avoid, and reduces movement and potential loosening of the bonded adhesive, and provides a protective covering over the outward edge of the top rail of the truck body.

According to one or more embodiments of the installation method and construction, it has been found by the inventors to be useful to provide a roof installation method of and construction onto a truck body using an edge cap with a combination of some or all of the following features:
i. The edge cap is specifically designed to and slide over top rail and clamp down on roof material,
ii. Three “points” (or three surfaces) of contact between the top rail of the truck body and the edge cap generate clamp force while bonding adhesive cures,
iii. The edge cap has a designed offset to provide space for an adhesive bead, strip, or layer to be held in place for bonding with a controlled thickness,
iv. The edge cap has a groove and a raised ridge designed to secure the roof edge cap permanently to the top rail to protect the roof edge, and
v. The bonding surface area seals edge between the roof sheet and the top rail materials eliminating water intrusion.

Further, it has been found by the inventors that it may be useful to accomplish roof installation on a truck body with the edge cap so that the use of holes, bolts or rivets, and the heavy tools required for installing a roof using them may be reduced or avoided. According to one or more embodiments of the invention, the roof installation and construction reduces ergonomic fatigue, seals against intrusion of water, and provides additional exterior roof edge protection.

Referring again to FIGS. 2 and 3, the elongated edge cap 50 is shown pressed onto the upper structural frame along one edge of the roof of the truck body. The upper structural frame rail and the edge cap are separately formed of metal, such as aluminum, as by extrusion to produce a length with the indicated unique cross-sectional shape there along.

According to one or more embodiments, the top rails 16 of the structural truck body frame 14 are cut to the appropriate length to form the shape of the truck body 12, typically a rectangular shape, and they are fastened together at corners to form the top of the truck body (e.g. a rectangle shaped may be constructed from four top rails 16) where the upper surface 18 of the top rails 16 are generally horizontally aligned at the desired height of the truck body roof 30. A sheet of roof material, such as an aluminum sheet or a vinyl sheet, is cut to form a corresponding size and rectangular shape of the frame top rails to lay on top of the top surfaces 18 defined by the top rails 16. The roof sheet 30 is placed horizontally on the top rails 16 to form the roof 30 there across. The roof edges are secured to the top surfaces of the top rails with a continuous layer of adhesive maintained during curing at a desired curing thickness.

The preceding schematic drawing figures depict one or more embodiments of installation along one of the roof edges. Additional details of the structure and assembled construction of one or more embodiments are shown in the cross-sectional drawings and example shop drawings. These are examples and the installation, construction, and process may be understood to be repeated for securing the roof to the opposed sides of the truck body for completion of the roof installation at the opposed edges of the roof and to seal and bond the roof edges to the top rail on the opposite side of the truck body. In one or more embodiments the roof may be bonded and sealed around the entire perimeter of the roof of a truck body.

According to one or more embodiments, a uniquely shaped elongated edge cap is formed with the unique cross-sectional shape there along and cut to one or more lengths, the end-to-end total length of which will closely match the lengths of the top rails of the upper truck body frame. Preferably, there will be lengths of the edge caps to install along each of the top edges of the truck body forming the perimeter of the truck body roof. A strip or a bead of adhesive is placed continuously along the upper surface of the top rails and the roof sheet is positioned on top of the adhesive, so the adhesive is “sandwiched” between the bottom of the roof sheet and the top of the edge rails continuously along the length of each rail. An edge cap is then moved over a laterally protruding rim of the top rai and through the unique geometry of the top rail and the edge cap is initially pushed and slides inward over the edge of the roof sheet so that adhesive remains pressed at a desired thickness between the roof sheet and the top rail.

According to one or more embodiments, an aspect of the unique edge cap geometry includes the spacing between the inside of the upper flange and the inside of the lower flange of the edge cap relative to the diameter of the rounded exterior edge of the top rail. The spacing is sufficiently wide and formed to allow the flanges of the edge cap to move over the rounded edge of the top rail while accommodating the height of the roof sheet with a layer of adhesive under it and between the roof sheet and the surface of the top rail, without squeezing out all of the adhesive layer. The edge cap is moved without significant restriction until the rounded end of the top rail meets a ridge formed to narrow the inter flange spacing and moving past the ridge mechanically causes the two flanges to be elastically spread until the rounded end of the top rail is moved past the ridge and inserted into the rounded crook of the edge cap and at the same inserted distance the end of the top flange is in the ending position over the roof sheet and adhesive. When the elasticity of the material of the edge cap returns to the normal (non-spread) position the end of the top flange is moved into contact with roof sheet and forces the roof sheet slightly downward and compressing through the roof edge against the adhesive layer 22 without squeezing out all of the adhesive. The roof edge is depressed a small distance sufficiently to accomplish continuous adhesive contact and bonding between and along the length of the roof sheet 30 edge 32 and the top rail 16.

Upon completely forcing the edge cap onto the top rail, the edge cap 50 holds the roof sheet 30 in place, while providing enough room between the roof sheet 30 and the top rail 16 for adhesive 20 to remain trapped there between. This spacing for the adhesive is accomplished with the geometry of the edge cap, the geometry of the top rail, the thickness of the roof sheet, and the compressibility of the adhesive strip or bead. This effectively provides three points of contact (in a cross-sectional view) to securely hold the roof sheet in place with adhesive compressed between the roof sheet and the top rail. In the case of a length of the edge cap installed along a length of the top rail, it will be understood by this disclosure that the “three points of contact” are effectively three lines of contact, extending between the edge cap and the top rail around the perimeter of the roof. The edge cap contacts the top rail in two places, one place of contact between an interior of the upper flange and the top 18 of the top rail 16 and another place of contact between interior surface of the lower flange and the bottom surface 25 of top rail 16. The locations may be established by the outward edge of the top rile 16 engaged in the interior crook 44 of the elbow 55 of the edge cap 50. Another place of contact is where the top flange of the edge cap contacts the roof sheet, and the roof sheet is effectively supported by the adhesive trapped against the top surface of the top rail (hence a third place of contact). The roof sheet is held securely with a thickness of adhesive adhering to both the roof sheet and the top rail, thereby bonding the roof in place and forming a continuous seal between the roof and the top rail. The adhesive material is selected to form a strong bond with the materials of the top rail and the roof sheet. Ultimately with adhesive between the roof sheet perimeter edges and the along each length of the frame top rails, a continuous strong bond and seal is effective formed. Because of the total area of the cured adhesive bond along the length of the top rail and roof edge, a mechanically strong roof structure is formed. One unique design aspect of the edge cap structure is that the edge cap remains self-clamped onto and protectively over the perimeter of the rounded edge of the top rail. It also remains in place over the perimeter or the roof sheet to both hold the roof sheet in place and protectively covered by the roof edge. This construction eliminates the use of holes, bolts or rivets, and the heavy tools required for installing a roof using them. It reduces ergonomic fatigue, seals against intrusion of water, and provides additional protection for both the roof sheet edge and the frame top rail edge against damage and wear by impact road debris, tree branches, rain, ice, or other environmental conditions associated with operating a moving truck body.

According to one or more embodiments of the installation method and construction, this construction eliminates the use of holes, bolts or rivets, and the heavy tools required for installing a roof using them. It reduces ergonomic fatigue, seals against intrusion of water, and provides additional protection for both the roof sheet edge and the frame top rail edge against damage and wear by impact road debris, tree branches, rain, ice, or other environmental conditions associated with operating a moving truck body.

Other aspects and advantages of the invention will be apparent from the following description and the appended claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A roof installation for securing a roof to a truck body of the type having a top frame of the truck body formed of plurality of connected top rails in a size and shape of the truck body and the top rails having a perimeter corresponding to the size and shape of an area over which the roof is to be installed, and the top rails having a surface area onto which the roof is to be secured, an exterior edge, and a substantially vertical support for connection to walls of the truck body, the roof installation comprising:
a) forming a roof sheet having a shape corresponding to the size and shape of the top frame and a roof edge sized for engaging the surface area of the top rails onto which the roof is to be secured;
b) applying an uncured adhesive in a layer thicker than the desired curing thickness and continuously along the surface of the top rail to which the roof is to be secured; c) forming an edge cap including an upper flange and lower flange connected together by a proximal clamp portion of the edge cap with interior surfaces of the upper flange and lower flange spaced apart by a predetermined structure of the edge cap to allow the lower flange to be pushed under and to engage against a bottom of the top rail and to allow the upper flange to be moved over and to engage the top rail and the roof edge aligned along the surface area of the top rails to which the roof is to be secured and to clamp against the roof edge with the uncured adhesive between the roof edge and the top surface at a predetermined clamping position, wherein the clamping position against the roof maintains the desired curing thickness of the adhesive and holds the roof in place for curing the adhesive; and
d) curing the adhesive while the roof is held in place for curing by the edge cap, so the adhesive is cured and bonds between the edge of the roof and the top rail with the desired adhesive curing thickness defined by the predetermined structure of the edge cap.

2. The truck body roof installation of claim 1, comprising a top rail having a predetermined rail thickness and having a rounded edge with a diameter greater than the thickness of the top rail and a raised ridge formed on an interior of the edge cap so that the edge cap is retained on the top rail by contact between the raised ridge and the rounded edge of the top rail.

3. The truck body roof installation of claim 1, wherein the top rail comprises a predetermined rail structure having top and bottom surfaces establishing a thickness of the top rail, and the upper flange of the edge cap comprises an interior contact surface positioned so that it frictionally engage the top surface of the top rail and the interior surface of the lower flange of the edge cap at interior contact surface positions so that it frictionally engages bottom surface of the top rail to retain the edge cap in place at the predetermined clamping position for maintaining the desired curing thickness of the adhesive.
